(19) United States
(12) Patent Application Publication
(10) Pub. No.: US 2024/0017800 A1
(43) Pub. Date: Jan. 18, 2024

(54) FLOATING BODY AND INSTALLATION METHOD THEREOF

(71) Applicant: BioHaven Environmental Solutions ( Zhejiang ) Co., Ltd., Taizhou (CN)

(72) Inventors: Yunyou XU, Taizhou (CN); Jingjing WANG, Taizhou (CN); Wenbo LIU, Taizhou (CN); Xin HE, Taizhou (CN); Wenjing QIN, Taizhou (CN); Shuang ZHENG, Taizhou (CN); Linhao LI, Taizhou (CN)

(21) Appl. No.: 18/353,041

(22) Filed: Jul. 14, 2023

(51) Int. Cl. B63B 35/44

(52) U.S. Cl. CPC B63B 35/44; B63B 2035/4453; B63B 2209/18

(57) ABSTRACT

A floating carrier includes an embedded holder assembly provided in the floating carrier. The embedded holder assembly includes a holder and a framework structure. The holder has an opening at one end. This application further provides a floating body fixing unit, a floating body, and a method for installing the floating body. The floating body fixing unit includes a metal grid and the floating carrier mounted in the metal grid. The floating carrier is mounted in the metal grid through the holder with an opening at one end, through which a metal cable is placed in the fixator. The opening is closed by a bolt.

### TECHNICAL FIELD

This application relates to water-surface photovoltaic systems, and more particularly to a floating photovoltaic product integrating water purification, superaqueous landscape construction, and floating photovoltaic technology.

### BACKGROUND

Energy is an important basis for ensuring normal social and economic development and improving the material standards of living. With the continuous development of human society, energy consumption has increased sharply, and the energy gap has become increasingly serious. Moreover, the burning of a great deal of fossil energy will exacerbate the global ecological environment problem, which also poses a serious threat to human survival and development. To deal with such challenges, the solar photovoltaic power generation technology has attracted considerable attention due to the unique renewability and cleanliness.

The commercially-available floating photovoltaic systems mainly includes a photovoltaic panel, a metal frame, and a floating body, and will occupy the water-surface living space of animals and plants on the when deployed on the water. The photovoltaic metal structure and plastic structure cannot provide enough space for the growth of animals and plants, and thus cannot improve the ecology. The large-scale deployment of the floating photovoltaic will greatly reduce the foraging and activity space of birds and amphibians.

During the practical deployment in the water body, the fixed point is connected to a certain point of the floating photovoltaic via fasteners, bolts, or cable ties. When the water photovoltaics are impacted by the water flow, the impact force will be concentrated in one or several parts, which may easily cause damage to the connection member or the plastic floating body near the connection member, thereby eventually separating the floating photovoltaic array. At the same time, the mutual squeezing between adjacent units will also damage the stress concentration part.

The floating photovoltaics are fixed on the water surface via the heavy object or by piling using multiple stainless-steel cables. However, when the product is under stress, the multiple stainless-steel cables fail to provide uniform tensile force, and the tensile force will be concentrated in some stainless-steel cables and their connection members. In this case, these connection members will be subjected to extremely large forces, and be prone to damage.

Regarding the current floating photovoltaic project, a lifting device is used to place the heavy object on the workboat, and then the heavy object is placed at the designated position through the lifting equipment on the workboat, where the upper end of the heavy object is provided with a buoy. The photovoltaic part needs to be assembled and installed on the shore, and then dragged to the designated place for fixing. The construction process requires bulky mechanical equipment, large labor consumption, and complex operation, which greatly reduces the construction efficiency.

Therefore, a photovoltaic power generation and ecological restoration integrated system is proposed to solve the problems of easy breakage at the connection between floating bodies, low construction efficiency and weak ecological function, and avoid the accidents caused by anchoring system failure, so as to enable the safe, environmentally-friendly and stable operation of the practical project, promoting promote the development of floating photovoltaic technology.

### SUMMARY

In view of the deficiencies in the prior art, this application provides a floating carrier, a floating body, and a floating body fixing unit. The floating body fixing unit includes the floating carrier provided in a metal grid. The floating carrier is installed in the metal grid through a holder with an opening at one end. A metal cable is disposed in the holder through the opening, and the opening is closed by a bolt, which facilitates the installation of the floating carrier and the replacement of the single floating carrier on the metal cable. The embedded holder assembly is integrated, so when encountering wind waves, the force received by the floating carrier can be transmitted to the metal cable through the embedded holder assembly, reducing the impact force applied to the floating carrier, the floating body fixing unit and the floating body, to improve the stability and prolong the service life. The floating body also has ecological functions, thereby enabling the integration of ecological effect and industrial power generation.

Technical solutions of this application are described as follows.

In a first aspect, this application provides a floating carrier, including:

an embedded holder assembly provided in the floating carrier;

wherein the embedded holder assembly comprises a holder and a framework structure.

In a second aspect, this application provides a floating body fixing unit, including:

a metal grid; and

the floating carrier;

wherein the floating carrier is provided in the metal grid.

In a third aspect, this application provides a floating body, including:

the floating carrier; and

a photovoltaic device fixedly provided on the floating carrier.

In a fourth aspect, this application provides a floating body, including:

the floating body fixing unit; and

a photovoltaic device fixedly provided on the floating body fixing unit.

In a fifth aspect, this application provides a method for installing the floating body, including:

(a) fixing the metal cable to form the metal grid;

(b) connecting the metal grid to the positioning system;

(c) mounting the photovoltaic device on the floating carrier; and

(d) mounting the floating carrier on the metal grid.

### BRIEF DESCRIPTION OF THE DRAWINGS

FIG. 1 schematically shows a structure of a floating wetland according to one embodiment of the present disclosure;

FIGS. 2a-2d structurally show holders according to several embodiments of the present disclosure;

FIG. 3 is a schematic view of a polyurethane foam structure according to one embodiment of the present disclosure;

FIG. 4 schematically shows a structure of a floating body fixing unit according to one embodiment of the present disclosure;

FIGS. 5-7 schematically shows a method for installing the floating body according to one embodiment of the present disclosure;

FIG. 8 schematically shows that a photovoltaic device and a leg support sleeve are mounted;

FIG. 9 schematically shows that a floating carrier and the leg support sleeve are mounted;

FIG. 10 schematically shows removal and installation of the floating carrier;

FIG. 11 schematically shows that a transverse metal cable and a longitudinal metal cable installed by a cross buckle;

FIG. 12 schematically shows that a metal grid is connected to a fixed pile;

FIG. 13 schematically shows that the metal grid is connected to a plurality of heavy objects; and

FIG. 14 schematically shows that the metal grid is connected to one heavy object.

In the figures: 1—metal grid; 11—transverse metal cable; 12—longitudinal metal cable; 2—floating carrier; 22—embedded holder assembly; 221—holder; 222—-framework structure; 223—support body; 2211—ring interface; 2212—fixed end; 2213—connecting end; 2214—free end; 3—leg support sleeve; 31—hollow casing tube; and 32—flat connector.

### DETAILED DESCRIPTION OF EMBODIMENTS

The disclosure will be described in detail below to make the features and advantages of the disclosure clearer and more unambiguous.

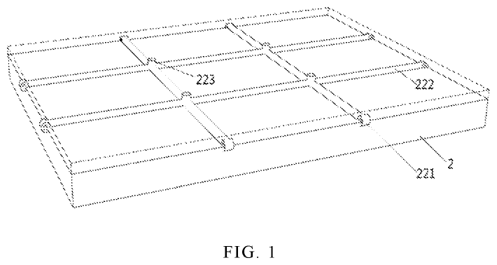

A floating carrier 2 provided herein includes an embedded holder assembly 22, and the embedded holder assembly 22 is disposed in the floating carrier 2. In an embodiment, the embedded holder assembly 22 is parallel to the bottom surface of the floating carrier 2, as shown in FIG. 1.

The distance between the embedded holder assembly 22 and the upper surface of the floating carrier 2 is 20˜100 mm, preferably 30˜50 mm, and more preferably 40 mm.

When the distance between the embedded holder assembly 22 and the upper surface of the floating carrier 2 is within the above distance range, the embedded framework holder has the least impact on the installation and transportation of the floating carrier 2 and has the best support effect. Moreover, when the floating carrier is impacted by wind waves, the holder has the best stability to the floating carrier 2.

The embedded holder assembly 22 includes a holder 221 and a framework structure 222. In an embodiment, the embedded holder assembly 22 is integrated. Compared with the detachable connection structure, the integrated connection structure can transmit and receive more uniform force and longer service life.

In the disclosure, the framework structure 222 is a symmetrical structure formed by crossing of a transverse beam and a longitudinal beam. When subjected to force impact, the symmetrical structure is more uniformly stressed than the asymmetric structure. The smaller the impact force caused to the part, the longer the service life.

In an embodiment, the framework structure 222 is a cross-shaped structure, an asterisk-shaped structure, or a tic-tac-toe structure.

In an embodiment, the framework structure 222 is a tic-tac-toe structure, as shown in FIG. 1. The tic-tac-toe structure can not only have a better support on the floating carrier 2, and have the more uniform force transmission and force, which is more convenient for integrated molding in industry.

The holder 221 is provided at the ends of the transverse beam and the longitudinal beam of the framework structure 222, and the holder 221 is configured in an openable-closable structure. The holder 221 is used to fix the floating carrier 2 on the metal cable. One end of the holder 221 is configured in an openable-closable structure, which is convenient to place the metal cable in the holder 221 when the openable-closable structure is opened. Then the openable-closable structure is closed, so that the floating carrier 2 sleeved on the metal cable can slide without falling off. When it is necessary to replace the floating carrier 2, it only need to disassemble the floating carrier 2 separately, which is more convenient to remove the floating carrier 2 from the metal cable and replace the old floating carrier 2 with a new floating carrier, thereby making installation, removal, and disassembly more convenient.

In an embodiment, the holder 221 is closed and tightened by bolts.

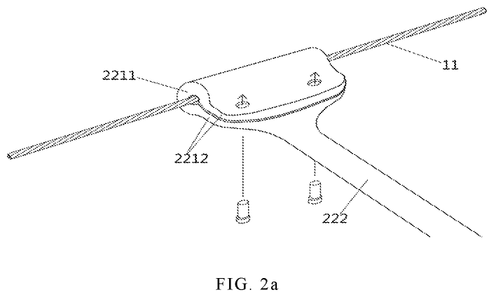

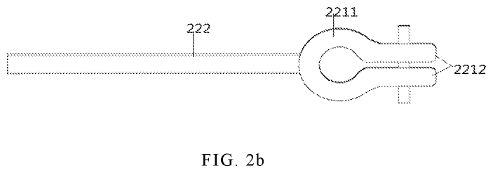

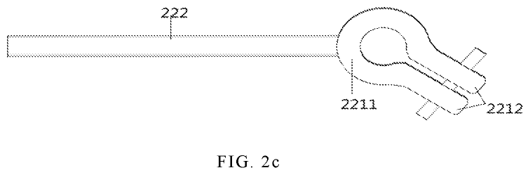

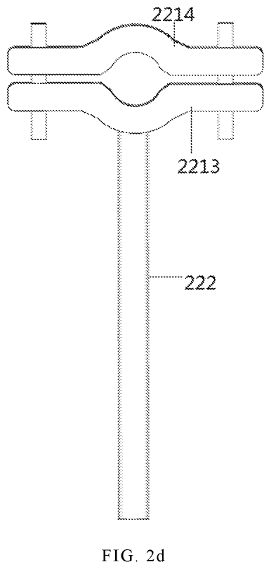

In an embodiment, the holder 221 is a “T”-shaped structure. As shown in FIG. 2a, the holder 221 includes a ring interface 2211 and a fixed end 2212. The section of the ring interface 2211 is ringlike with a notch. The ring interface 2211 is used to allow the metal cable to pass through. The fixed end 2212 consists of two sheets parallel to each other, which are respectively located above and below the notch of the ring interface 2211, respectively. A bolt insertion hole is provided on the fixed end 2212. In this embodiment, the number of the bolt insertion holes is two. The two bolts are inserted into the bolt insertion holes to close the holder 221, as shown in FIG. 2a.

In this embodiment, the holder 221 is connected to the end of the framework structure 222 by the sheet above or the sheet below the fixed end 2212. In other words, one end of the sheet above or one end of the sheet below the fixed end 2212 is connected to the ring interface 2211, and the other end is connected to the framework structure 222, as shown in FIG. 2a. Or the holder 221 is connected to the end of the framework structure 222 through the ring interface 2211, and the angle between the notch direction and the axis of the framework structure 222 is 1˜180°, preferably 180° and 135°, as shown in FIG. 2b and FIG. 2c, respectively.

In this embodiment, the holder 221 includes a connecting end 2213 and a free end 2214. The connecting end 2213 is connected to the end of the framework structure 222.

After splicing, the connecting end 2213 and the free end 2214 may form a circular ring. The metal cable may insert into the circular ring. Moreover, the connecting end 2213 and the free end 2214 further include a bolt insertion hole. The bolt is inserted into the bolt insertion hole to close the holder 221.

In this embodiment, the cross-sectional shapes of the connecting end 2213 and the free end 2214 are the same, and both semi-rings. The two ends of each of the semi-rings are sheets with the bolt insertion hole. After the metal cable passes through the ring formed by the semi-rings, and then the holder 221 is closed by inserting the bolts into the bolt insertion hole, as shown in FIG. 2d.

In an embodiment, the cross-sectional shape of the embedded holder assembly 22 is round, oval or rectangular, preferably circular or oval. The round or oval shape is more rounded, and when the floating carrier 2 is subjected to wind, it will not form a stress concentration and cause damage to the floating carrier 2.

The diameter of the transverse beam and the longitudinal beam of the framework structure 222 is 15˜40 mm, preferably 20 mm. The larger the diameter of the transverse beam and the longitudinal beam, when subjected to wind waves, the smaller the pressure of the embedded holder assembly 22 on the floating carrier, the less likely the floating carrier to be damaged. But the diameter of the transverse beam and the longitudinal beam is too large, and the weight of the embedded holder assembly 22 increases, which is not conducive to the floating of the floating carrier on the water surface and installation of other devices on the floating carrier, reducing the functionality of the floating carrier.

The embedded holder assembly 22 further includes a support body 223. The support body 223 is perpendicularly provided on the upper surface of the framework structure 222, preferably located at the intersection of the transverse beam and the longitudinal beam, as shown in FIG. 1. More preferably, the support body 223 is symmetrically distributed on the embedded holder assembly 22.

When other devices such as photovoltaic devices are installed on the floating carrier 2, the support body 223 as a fixed connection structure mounts the devices on the floating carrier 2, and symmetrical distribution can make the devices mounted on the floating carrier more stable.

The cross-section of the support body 223 is round, oval, diamond or rectangular, preferably round or oval.

Preferably, the diameter of the support body 223 is 35˜60 mm, preferably 40 mm. When the diameter of the support body 223 is in the range of 35˜60 mm, the support body 223 is used as a fixed connection structure with other devices with strong bearing capacity and stronger connection, also can reduce the quality of the embedded holder assembly 22.

The embedded holder assembly 22 is made of a polymer material, preferably an innocuous polymer material with good insulation, good chemical stability, acid and alkali corrosion resistance and high temperature resistance. The tensile strength of the used polymer material is higher than 20 MPa, and the elongation at break of the used polymer material is greater than or equal to 350%, such as high-density polyethylene materials.

Compared with metal materials, polymer materials have low density. In the same volume, compared with metal materials, the weight of polymer materials is smaller. Moreover, compared to metal materials, the polymer materials have better impact resistance. After stressed, metal materials often undergo plastic deformation, have poor deformation recovery. When stressed again, the part undergoing plastic deformation is prone to re-deformation, resulting in short service life. However, the used polymer materials after stress undergo elastic deformation, and have good deformation recovery and longer service life.

In an embodiment, the floating carrier is a floating wetland or a polyurethane foam. The floating wetland as the floating carrier can make up for the lack of ecological functions of the current water photovoltaics. The polyurethane foam can further improve the stability of floating carriers under wind and waves.

The floating wetland is prepared from a plurality of polymer fiber layers. The material of the plurality of polymer fiber layers has a specific surface area of 1: (2000˜10000), preferably 1: (2000˜3000). Each of the plurality of polymer fiber layers has a porosity of 80˜99%, preferably 90˜99%. The polymer fiber layer with the specific surface area of 1: (2000˜10000) and the porosity of 80˜99% can dampen the water flow and achieve the effect of reducing waves. The polymer fiber layer with the specific surface area of 1: (2000˜10000) and the porosity of 80˜99% can provide much living space for microorganisms, help to form biofilms on the surface of polymer fiber materials, increase the contact area between biofilms and water, and can also meet the needs of plant growth and rooting. The above porosity also guarantees that the floating carrier has a certain buoyancy.

The tensile strength of the polymer fiber layer is 30˜60 kPa, preferably 40˜55 kPa. The tensile strain corresponding to the tensile strength range is 60%˜90%, preferably 70%˜80%.

The polymer fiber layer has high compressive and impact resistance in the horizontal and vertical directions, ensuring that the polymer fiber layer can withstand large water currents, wind and wave impacts in rivers, lakes and seas without damaging the structure.

The polymer fiber is a polyethylene terephthalate fiber, preferably the polymer fiber is prepared by terephthalic acid, ethylene glycol, flame retardant, antioxidant and heat stabilizer.

The flame retardant is selected from the group consisting of the organic hypophosphite halogen-free flame retardants, preferably selected from the group consisting of aluminum diethylphosphinate, ammonium polyphosphate, 9,10-Dihydro-10-(2,3-dicarboxypropyl)-9-oxa-10-phosphaphenanthrene 10-oxide (DPP), and 9,10-dihydro-9-oxa-10-phosphophenanthrene-10-oxide (DOPO), and a mixture thereof.

Antioxidants are selected from the group consisting of antioxidant 1010, antioxidant 168, p-tert-butylcatechol and a combination thereof, preferably antioxidant 1010, antioxidant 168 or a combination thereof.

The heat stabilizer is selected from one or more of phosphite heat stabilizers, preferably from one or both of triphenyl phosphite (TPP) and trimethyl phosphite.

In addition to the high specific surface area, the polymer fiber also has high thermal stability, oxidation resistance and flame retardancy, which further improves the service life of the floating carrier.

The floating carrier in the disclosure can provide buoyancy greater than 50 kg/m², which can meet the planting of all aquatic plants and some trees and shrubs, and at the same time can meet the installation of photovoltaic devices, so that the floating carrier not only has ecological functions, but also meets industrial power production needs.

The floating wetland has the very high specific surface area and porosity, providing more sites for microbial growth and adsorption, which can achieve better water purification effect. The floating wetland has high biohydrophilicity, which can provide a green place for rich growth of plants, animal predation and habitat, and build a complex ecological environment.

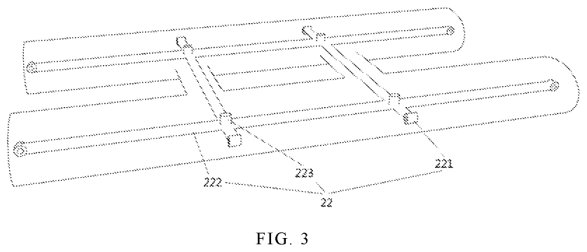

The polyurethane foam body is rectangular, rhombus-shaped, star-shaped, tic-tac-toe or cross-shaped. In an embodiment, the polyurethane foam body and the embedded holder assembly 22 has the same shape, the embedded holder assembly 22 may be completely coated in the polyurethane foam body, as shown in FIG. 3.

Polyurethane has excellent shock absorption, cushioning performance, good compressive load resistance and deformation recovery performance, which further improves the stability of the floating carrier on large wind and waves.

More preferably, the cross-sectional diameter of the polyurethane foam body is 10˜15 times the cross-sectional diameter of the embedded holder assembly 22, preferably 10 times.

When the cross-sectional diameter of the polyurethane foam is within the range of multiples of the cross-sectional diameter of the embedded holder assembly, the polyurethane foam body can be used as the floating carrier.

In an embodiment, one or more of polyurea, polyurethane, epoxy resin, nano-coating is sprayed on the surface and inside of the floating carrier, preferably one or more of polyurea, polyurethane and epoxy resin, more preferably polyurea.

After testing, it has been found that spraying the above polymer on the surface of the floating carrier can enhance the integration of the floating carrier. Moreover, the above polymer has the advantages of high ignition point and corrosion resistance, and so spraying the above polymer can also improve the flame retardancy, corrosion resistance and waterproofness of the floating carrier, and improve the service life.

Preferably, the upper surface and side of the floating carrier are sprayed with the above polymers, and the lower surface is not sprayed, which can ensure that the floating carrier has a certain water permeability, which is conducive to the growth of microorganisms and plants in the floating carrier.

More preferably, the spraying thickness is 0.4˜1 mm, preferably 0.5 mm, which can ensure that the floating carrier has good corrosion resistance and waterproofness.

In the second aspect, this disclosure provides a floating body fixing unit including the above floating carrier.

The floating body fixing unit includes a metal grid 1 and the floating carrier 2 which is provided in the metal grid 1.

In this embodiment, the metal grid 1 includes a transverse metal cable 11 and a longitudinal metal cable 12 fixed by a fastener.

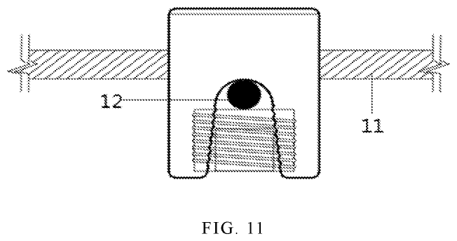

In an embodiment, the fastener is a cross buckle or a U-shaped clamp, preferably the cross buckle. More preferably, the transverse metal cable 11 and the longitudinal metal cable 12 in the cross buckle are installed and arranged in an alternating manner up and down, as shown in FIG. 11. The fixing manner makes the connection of the metal grid 1 firmer, effectively avoiding that when the cross buckle or the U-shaped clamp at a certain site is failed, the other metal cable grids connected to the certain site are scattered.

The metal grid and the metal cable are made of stainless steel, aluminum alloy or galvanized steel, preferably stainless steel or aluminum alloy, and more preferably stainless steel.

The floating carrier 2 is detachably connected to the metal grid 1, so any contour pattern can be spliced to meet the needs of a variety of modeling and landscape design of water photovoltaics. Moreover, compared with the rigid connection method in the prior art, the detachable flexible connection method can disperse the force of the floating carrier 2, thereby avoiding damage to the stress concentration part, and then solving the problem of general water photovoltaic fixation and connection point fragility.

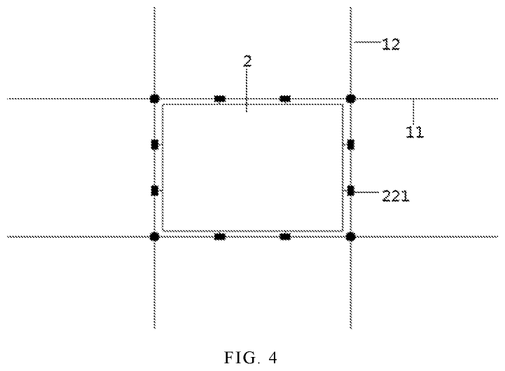

The floating carrier 2 includes the embedded holder assembly 22, and the embedded holder assembly 22 is located at the floating carrier 2. The floating carrier 2 is mounted in the metal grid 1 through the embedded holder assembly 22. More preferably, after the transverse metal cable 11 and the longitudinal metal cable 12 in the metal grid 1 pass through the holder 221 to fix the floating carrier 2 in the metal grid 1 by bolts, as shown in FIG. 4. The floating carrier 2 is sleeved in the transverse metal cable 11 and the longitudinal metal cable 12 to slide without falling off. When a horizontal pulling force is applied, the floating carrier 2 can slide along the metal cable. When a force perpendicular to the direction of the floating carrier 2 is applied, the floating carrier 2 will not be moved, the force will be transmitted to the holder 221 and the metal grid 1 through the embedded holder assembly 22, and the force is dispersed to avoid damage to the floating carrier 2.

In an embodiment, the diameter of the transverse metal cable 11 and the longitudinal metal cable 12 is the same, and the diameter is 7˜15 mm, preferably 8 mm.

Preferably, the transverse metal cable 11 and the longitudinal metal cable 12 have the same tensile strength greater than the tensile strength of the embedded holder assembly 22. The tensile strength of the transverse metal cable 11 and the longitudinal metal cable 12 is 1700 MPa˜2500 MPa, preferably 1800˜2300 MPa. When impacted by wind waves, the main stress structure of the system is the metal grid 1 and the embedded holder assembly 22, and the floating carrier can slide on the metal cable within a certain range, thereby avoiding the problem of excessive stress concentration caused by rigid connection and solving the vulnerability of fixing points and connection points of the general floating carriers.

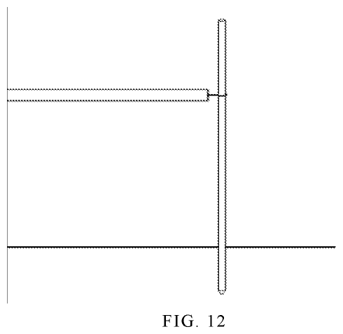

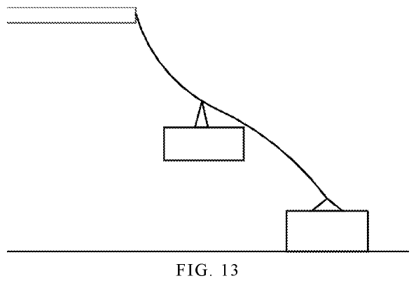

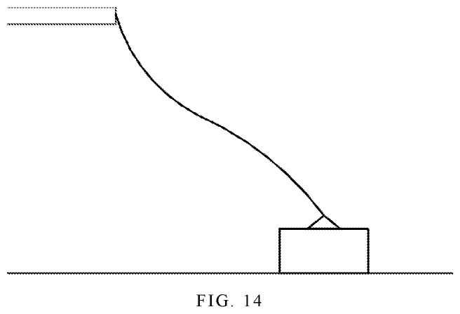

The metal grid 1 is connected to a positioning system, as shown in FIGS. 12-14. The positioning system is generally a fixed pile, a metal anchor, or a heavy object connected to the metal cable. The metal grid is positioned by the positioning system.

When the water flow is gentle, the positioning system is generally composed of the heavy objects connected to metal cables, including one or more of the stones and cement prefabricated parts.

At the center of the ocean or lake, the positioning system uses the metal anchor. The metal grid 1 is connected to the positioning system by the transverse metal cable 11, the cross buckle or the U-shaped clamp.

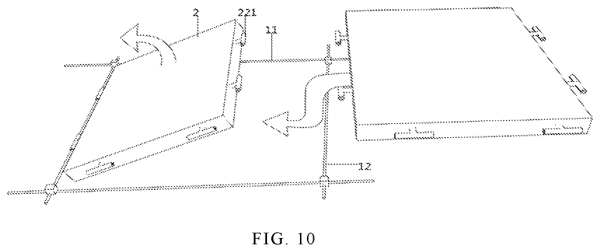

The floating body fixing unit can form the required floating body through a plurality of units arranged horizontally and vertically. When replacing the floating carrier, it only needs to disassemble the single floating carrier in the metal grid 1 separately, as shown in FIG. 10. The floating carrier can be manually disassembled or replaced, which is easy to operate.

The floating body fixing unit can provide a buoyancy of 50˜80 kg/m², which can be fully used to install the photovoltaic devices and other devices. The floating body fixing unit has strong stability, and the devices installed on floating body fixing unit will not roll over or collide when subjected to strong wind and waves.

In the third aspect, the disclosure further provides a floating body. The floating body includes the floating body carrier fixing unit described above, and a photovoltaic device.

The photovoltaic device is fixed to the floating carrier 2 by a leg support sleeve 3. One end of the leg support sleeve 3 is a hollow casing tube 31, the hollow casing tube 31 is sleeved on the support body 223, and the other end of the leg support sleeve 3 is a flat connector 32.

The cross-sectional shape of the hollow casing tube 31 is the same as the cross-sectional shape of the support body 223, and the cross-sectional area of the hollow casing tube 31 is slightly larger than the cross-sectional area of the support body 223, ensuring that the support body 223 may be embedded in the hollow casing tube 31 of the leg support sleeve 3.

One end of the leg support sleeve 3 is cylindrical, which is not only more convenient to install, but also can achieve three-dimensional pressure bearing and have better pressure-bearing capacity.

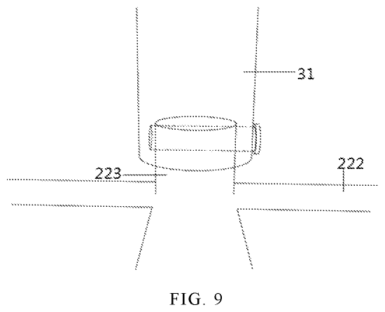

When mounting the photovoltaic device, the self-tapping screw passes through the hollow casing tube 31 into the support body 223, so that the leg support sleeve 3 is mounted on the floating carrier 2, as shown in FIG. 9.

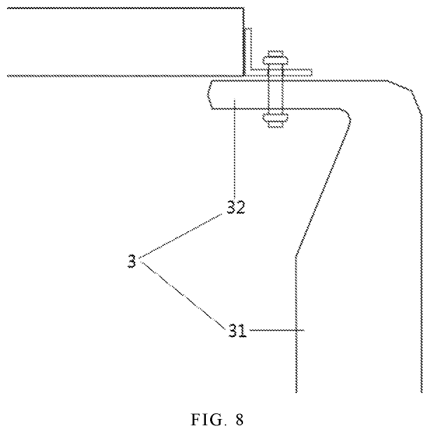

The flat connector 32 is connected to the top of the frame of the photovoltaic device. The self-tapping screw passes through the top of the frame of the photovoltaic device and the flat connector 32, and the photovoltaic device is mounted on the leg support sleeve 3, thereby mounting the photovoltaic device on the floating carrier 2 through the leg support sleeve 3, as shown in FIG. 8.

The angle between the axis of the flat connector 32 and the axis of the hollow casing tube 31 is 70°˜90°, preferably 77°˜90°. The photovoltaic device is at a certain angle to the horizontal direction by adjusting the angle between the flat connector 32 and the hollow casing tube 31.

The installation angle of the photovoltaic device and the horizontal direction is 0°˜50°, and the installation angle of the photovoltaic device depends on the latitude of the installation position. Corresponding to different latitudes, the installation angle of photovoltaic devices will be adjusted adaptively.

The photovoltaic device is installed in the center of the floating carrier to avoid collision between the two photovoltaic devices when subjected to wind and waves, resulting in damage to the photovoltaic devices.

The area of the floating carrier 2 is 0.6˜1 m² larger than the area of the photovoltaic device, preferably 0.66 m².

The distance between two adjacent photovoltaic devices is 17˜30 cm, preferably 20 cm.

After testing, it is found that the area of the floating carrier is 0.6˜1 m² larger than the area of the photovoltaic device, which can ensure that the distance between the two adjacent photovoltaic devices is greater than 17˜30 cm, and ensure that when the floating carrier is subjected to large wind and waves, collisions between adjacent photovoltaic devices will not occur, resulting in damage to the photovoltaic devices.

Moreover, the floating carrier adopts the above installation method, which has good stability and the low probability of collision between the adjacent photovoltaic devices.

In the fourth aspect, the disclosure provides a method for mounting the floating body. The method includes the following steps.

(1) The metal cables are fixed to form the metal grid 1.

(2) The metal grid is connected to the positioning system.

(3) The photovoltaic device is mounted on the floating carrier 2.

(4) The floating carrier 2 with the photovoltaic device is mounted on the metal grid 1.

A detailed description of each of these steps follows.

(1) The metal cables are fixed to form the metal grid 1.

The transverse metal cable 11 and the longitudinal metal cable 12 are fixed by the cross buckle or the U-shaped clamp, preferably the cross buckle. By means of four cross buckles, two parallel transverse metal cables 11 and two parallel longitudinal metal cables 12 are fixed to form the metal grid 1.

Preferably, the transverse metal cable 11 and the longitudinal metal cable 12 are installed in an alternating up-and-down arrangement, to avoid the metal cable grid scattering when the holder at a certain point fails, so that the metal grid 1 is spliced more firmly.

(2) The metal grid is connected to the positioning system.

The positioning system is generally fixed piles, metal anchors or heavy objects attached to metal cables.

When the water flow is gentle, the positioning system is generally composed of the heavy objects connected to metal cables, including one or more of the stones and cement prefabricated parts.

In the ocean, the positioning system uses the metal anchor. The metal grid 1 is connected to the positioning system by the transverse metal cable 11, the cross buckle or the U-shaped clamp.

(3) The photovoltaic device is mounted on the floating carrier 2.

The photovoltaic device is installed on the floating carrier 2 through the leg support sleeve 3. Specifically, the self-tapping screw first passes through the top of the frame of the photovoltaic device and the flat connector 32 on the leg support sleeve 3, and the photovoltaic device is mounted on the leg support sleeve 3.

Then, the support body 223 is inserted in the hollow casing tube 31 of the leg support sleeve 3. The self-tapping screw is nailed diagonally or vertically from the hollow casing tube 31 into the support body 223, so that the leg support sleeve 3 is mounted on the floating carrier 2, thereby completing the installation of the photovoltaic device on the floating carrier 2.

The installation angle of the photovoltaic device and the horizontal direction is 0°˜50°.

(4) The floating carrier 2 with the photovoltaic device is mounted on the metal grid 1.

The transverse metal cable 11 and the longitudinal metal cable 12 on the metal grid 1 are threaded into the ring interface 2211, and then the bolt is threaded into the bolt insertion hole on the fixed end 2212 to close the holder 221, so that the floating carrier 2 is mounted on the metal grid 1.

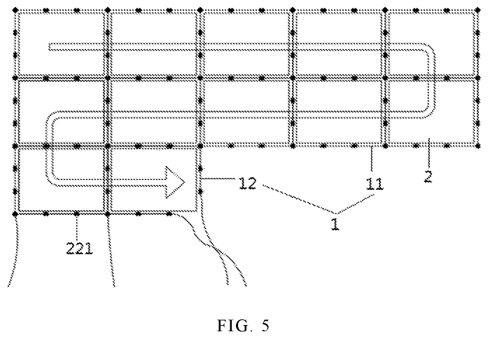

If the user wants to continue to install the floating carrier 2, it is necessary to first form a new metal grid 1 on the basis of the original metal grid 1 by means of the cross buckle or the U-shaped clamp, and then the floating carrier 2 installed with photovoltaic devices is installed in the new metal grid 1, as shown in FIG. 4 and FIG. 5.

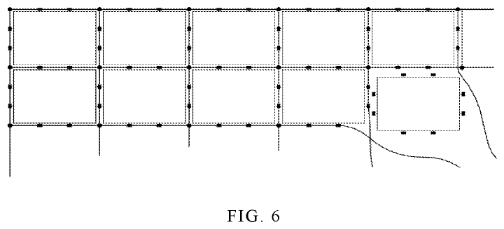

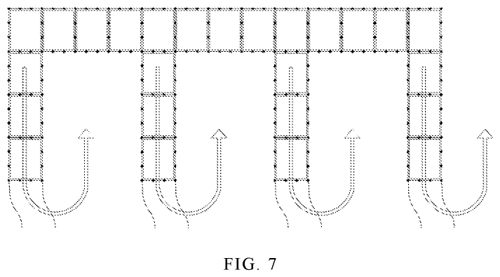

The above installation can be performed in situ in multiple rows and multiple columns at the same time, as shown in FIGS. 5-7. Compared to the prior art, the complex installation method of shore assembly and dragging of the photovoltaic device can be avoided. Moreover, the installation and fixing of the floating carrier 2 can be realized through bolts, which only needs the simple tools and accessories, and can be manually disassembled and replaced, and the installation is convenient and efficient.

Compared to the prior art, this application has the following beneficial effects.

(1) The installation method of the floating body is simple, and the installation can be chain-mounted and performed in situ in multiple rows and multiple columns at the same time.

(2) The installation method avoids the complex installation method of assembling and installing photovoltaic device on the shore and dragging, and splice and install at multiple points at the same time, which greatly improves the installation speed of the project.

(3) The floating carrier is made of a plurality of polymer fiber layers with a high specific surface area and porosity, which can damp the fluid to reduce wind waves, and each of the plurality of polymer fiber layers has high tensile strength and tensile strain, which can withstand large water currents and wind-wave impacts without being damaged.

(4) The surface of the floating carrier is sprayed with polymer materials such as polyurea, which not only improves the integration of the floating carrier, but also provides the good flame retardancy, corrosion resistance and waterproofness of the floating carrier, and effectively prolongs the service life of the floating carrier.

(5) The floating body has an ecological function, thereby making up for the lack of ecological function of water photovoltaics. The floating wetland has the very high specific surface area and porosity, thereby providing more sites for microbial growth and adsorption, which can achieve good water purification effect. The floating wetland has high biological affinity, which can provide a green place for rich growth of plants, animal predation and habitat, and integrates ecological and industrial power generation.

(6) The water surface floating carrier has a damping effect and can disperse the impact force of the wind and waves in each carrier. Each carrier then transmits the force through the holder to the metal grid. The structure uses the characteristics of each component to avoid damage caused by excessive force on parts caused by stress concentration, thereby forming the stable and long-term floating system.

(7) The floating carrier transmits the force of the wave, wind, and other external environment to the anchor and other positioning parts fixed under the water through the metal grid, so as to eliminate the impact force of the floating carrier to ensure the stability of the floating carrier.

As used herein, it should be understood that the orientation or positional relationship indicated by the terms “up”, “down”, “inside”, “outside”, “front”, “rear”, etc. is based on the orientation or position relationship in the working state of the disclosure, which is only for the convenience of describing the technical solutions and simplifying the description, rather than indicating or implying that the indicated device or element must have a specific orientation, be constructed or operated in a specific orientation. Therefore, these terms should not be understood as a limitation of the present disclosure. In addition, the terms “first”, “second”, “third”, and “fourth” are merely descriptive, and cannot be understood as indicating or implying relative importance.

As used herein, unless otherwise expressly specified and defined, terms, such as “mount” and “connect”, should be understood in a broad sense, for example, it may be fixed connection, detachable connection, or integral connection; it may be mechanical direction or electrical connection; it may be direct connection or indirect connection through an intermediate medium; and it may be an internal communication between two members. For those skilled in the art, the specific meanings of the above terms can be understood according to specific situations.

Described above are merely preferred embodiments of the disclosure, which are not intended to limit the disclosure. It should be understood that any modifications and replacements made by those skilled in the art without departing from the spirit of the disclosure should fall within the scope of the disclosure defined by the present claims.

What is claimed is:

1. A floating carrier, comprising:
an embedded holder assembly provided in the floating carrier;
wherein the embedded holder assembly comprises a holder and a framework structure.

2. The floating carrier of claim 1, wherein the framework structure is a symmetrical structure formed by crossing of a transverse beam and a longitudinal beam; the holder is provided at ends of the transverse beam and the longitudinal beam; and the holder is configured in an openable-closable structure.

3. The floating carrier of claim 2, wherein the framework structure is a cross-shaped structure, an asterisk-shaped structure, or a tic-tac-toe structure.

4. The floating carrier of claim 2, wherein the embedded holder assembly further comprises a support body; and the support body is perpendicularly provided on an upper surface of the framework structure.

5. The floating carrier of claim 4, wherein the support body is provided at an intersection of the transverse beam and the longitudinal beam.

6. The floating carrier of claim 1, wherein the embedded holder assembly is made of a polymer material with a tensile strength of higher than 20 MPa and an elongation at break of greater than or equal to 350%.

7. The floating carrier of claim 1, wherein the floating carrier is a floating wetland or a polyurethane foam;
the floating wetland is prepared from a plurality of polymer fiber layers; and a material of the plurality of polymer fiber layers has a specific surface area of 1:
(2000˜10000); and
each of the plurality of polymer fiber layers has a porosity of 80˜99%, a tensile strength of 30˜60 kPa, and a tensile strain of 60˜90% in a range of the tensile strength from 30 kPa to 60 kPa.

8. The floating carrier of claim 1, wherein a surface and an inside of the floating carrier are sprayed with one or more of polyurea, polyurethane, epoxy resin and nano-coating; and the floating carrier is configured to provide a buoyancy force of greater than 50 kg/m².

9. A floating body fixing unit, comprising:
a metal grid; and
the floating carrier of claim 1;
wherein the floating carrier is provided in the metal grid.

10. The floating body fixing unit of claim 9, wherein the metal grid comprises a transverse metal cable and a longitudinal metal cable; and
the transverse metal cable and the longitudinal metal cable are fixed by a fastener.

11. The floating body fixing unit of claim 10, wherein the floating carrier is mounted in the metal grid through the embedded holder assembly.

12. A floating body, comprising:
the floating carrier of claims 1; and
a photovoltaic device fixedly provided on the floating carrier.

13. The floating body of claim 12, wherein the photovoltaic device is fixed to the floating carrier by a leg support sleeve;
one end of the leg support sleeve is a hollow casing tube, and the other end of the leg support sleeve is a flat connector; and the hollow casing tube is sleevedly provided on a support body; and
an angle between an axis of the flat connector and an axis of the hollow casing tube is 70°˜90°.

14. A floating body, comprising:
the floating body fixing unit of claim 9; and
a photovoltaic device fixedly provided on the floating body fixing unit.

15. The floating body of claim 14, wherein the photovoltaic device is fixed to the floating carrier by a leg support sleeve;
one end of the leg support sleeve is a hollow casing tube, and the other end of the leg support sleeve is a flat connector; and the hollow casing tube is sleevedly provided on a support body; and
an angle between an axis of the flat connector and an axis of the hollow casing tube is 70°˜90°.

16. A method for installing the floating body of claim 14, comprising:
mounting the photovoltaic device on the floating carrier; and
mounting the floating carrier on the metal grid.
